(19) United States
(12) Patent Application Publication
(10) Pub. No.: US 2013/0343382 A1
(43) Pub. Date: Dec. 26, 2013

(54) RELAY DEVICE, SET VALUE SETTING METHOD, AND RELAY SYSTEM

(71) Applicant: FUJITSU LIMITED, Kawasaki (JP)

(72) Inventors: Takeshi OWAKI, Kawasaki (JP); Daisuke Ito, Kawasaki (JP); Junji Ichimiya, Yokohama (JP); Atsushi Morosawa, Kawasaki (JP); Norihiko Fukuzumi, Ashigarasimogun (JP)

(73) Assignee: FUJITSU LIMITED, Kawasaki (JP)

(21) Appl. No.: 13/975,618

(22) Filed: Aug. 26, 2013

Related U.S. Application Data
(63) Continuation of application No. PCT/JP2011/054972, filed on Mar. 3, 2011.

(51) Int. Cl. H04L 12/721

(52) U.S. Cl. CPC H04L 45/72
USPC 370/389

(57) ABSTRACT

A relay device includes a first determining unit, a first sending unit, a receiving unit, a setting unit, a second determining unit, and a second sending unit. When the first determining unit determines that the relay device is a parent node, the first sending unit sends a set value stored in a storing unit to all the other relay devices to which the relay device is connected. When the first determining unit determines that the relay device is not the parent node, the receiving unit receives the set value. The setting unit sets the set value received by the receiving unit in the storing unit. When the second determining unit determines that the received set value has not been sent to the other relay devices, the second sending unit sends the received set value to the other relay devices to which the relay device is connected.

### CROSS-REFERENCE TO RELATED APPLICATION

This application is a continuation of International Application No. PCT/JP2011/054972, filed on Mar. 3, 2011, the entire contents of which are incorporated herein by reference.

### FIELD

The embodiments discussed herein are related to a relay device, a set value setting method, and a relay system.

### BACKGROUND

In a related relay system to which ports of multiple relay devices are connected, a relay device extracts a destination address included in data, refers to a routing table, and then sends the data to the extracted destination address.

The routing table is previously set by an administrator or is set by the relay devices exchanging information in accordance with a routing protocol. However, because the routing table is not set immediately after the power supply of each of the relay devices is turned on, the relay devices are not able to send the received data. Consequently, there is a known technology about relay devices that automatically creates a default route immediately after the power supply is turned on.

Furthermore, in addition to the relay device automatically creating a default route, set values, such as the size of a sending buffer, the flow of an error correction process, and the system configuration, which are used for the operation of the relay device, are set in the relay device. Such set values are set by an administrator by using a management terminal that is connected via a system management bus (SMBus).
Patent Document 1: Japanese Laid-open Patent Publication No. 2002-359638

However, with the related technology, there is a problem in that it is not possible to efficiently set a set value in multiple relay devices.

For example, an administrator needs to set a set value in each of the multiple relay devices. Consequently, as the number of relay devices increases, the number of relay devices in each of which a set value needs to be set by the administrator increases. In other words, it is difficult to efficiently set a set value in each of the relay devices.

Furthermore, there may be a case in which a set value is set such that a relay device sends data that includes a set value to another relay device connected to the sending source of the relay device. In such a case, because a routing table has not been set in a relay device immediately after the relay device's power supply is turned on, the relay device creates a default route and then sends the data. Specifically, a relay device is not able to efficiently set a set value immediately after its power supply is turned on.

Furthermore, there may also be a case in which a relay device broadcasts data that includes a set value without referring to a routing table. However, in such a case, in the portion in which the connection of the relay device is in a loop form, a loop occurs in which broadcasted data is repeatedly sent and received. Consequently, if a relay device broadcasts data to the other relay devices, the relay device is not able to efficiently set a set value.

### SUMMARY

According to a first aspect of an embodiment, a relay device determines whether the relay device is a parent node that sends a set value to other relay devices. If it is determined that the relay device is a parent node, the relay device sends a set value stored in a storing unit to all of the other relay devices to which the relay device is connected. Furthermore, if it is determined that the relay device is not a parent node, the relay device receives a set value and sets the received set value in the storing unit. Then, the relay device determines whether the received set value is sent from the relay device to the other relay devices. If it is determined that the received set value is not sent to the other relay devices, the relay device sends the received set value to the other relay devices to which the relay device is connected.

According to a second aspect of an embodiment, a relay device receives a set value and sets the received set value in a storing unit. Furthermore, the relay device determines whether the received set value has been sent. If it is determined that the set value has not been sent, the relay device sends the set value to all of other relay devices to which the relay device is connected.

According to a third aspect of an embodiment, a relay device extracts a set value stored in a storing unit and sends the extracted set value to all of other relay devices to which the relay device is connected.

According to an aspect of an embodiment, a relay device includes a first determining unit, a first sending unit, a receiving unit, a setting unit, a second determining unit, and a second sending unit. The first determining unit determines whether the relay device is a parent node that sends a set value to other relay devices. The first sending unit sends, when the first determining unit determines that the relay device is the parent node, the set value stored in a storing unit to all of the other relay devices to which the relay device is connected. The receiving unit receives the set value when the first determining unit determines that the relay device is not the parent node. The setting unit sets the set value received by the receiving unit in the storing unit. The second determining unit determines whether the set value received by the receiving unit has been sent from the relay device to the other relay devices. The second sending unit sends, when the second determining unit determines that the received set value has not been sent to the other relay devices, the received set value to the other relay devices to which the relay device is connected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example configuration of a relay system according to a first embodiment;

FIG. 2 is a schematic diagram illustrating the operation of a process performed by a relay device;

FIG. 3 is a block diagram illustrating the configuration of the relay device according to the first embodiment;

FIG. 4 is a schematic diagram illustrating an initialization packet created by a packet creating unit;

FIG. 5 is a table illustrating the result of determining, performed by a packet control unit on the basis of the content of each register, as to whether a packet has permission to be sent;

FIG. 6 is a flowchart illustrating the flow of a process performed by the relay device according to the first embodiment; and

FIG. 7 is a block diagram illustrating a computer that executes a set value setting program.

### DESCRIPTION OF EMBODIMENTS

Preferred embodiments of the present invention will be explained with reference to accompanying drawings. The present invention is not limited to these embodiments.

### [a] First Embodiment

Configuration of a Relay System According to a First Embodiment

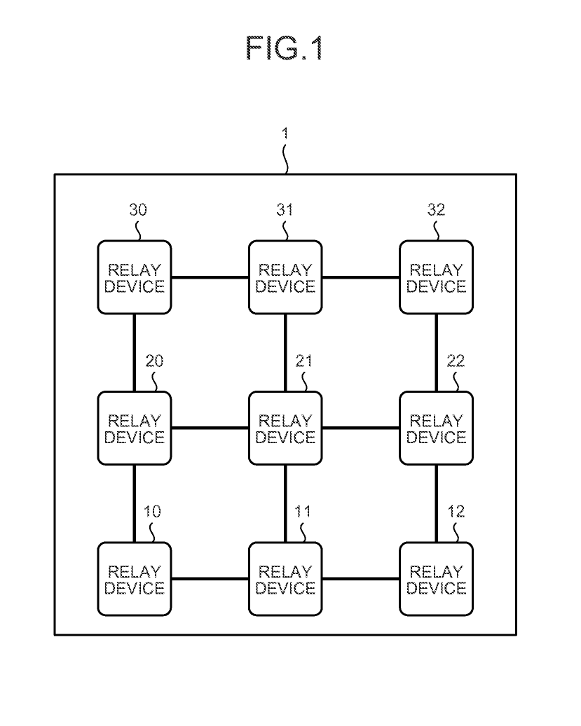

First, a relay system according to a first embodiment will be described with reference to FIG. 1. In the following, descriptions will be given in the following order: the configuration of the relay system according to the first embodiment, the operation of a process performed by the relay system according to the first embodiment, the configuration of the relay device according to the first embodiment, the flow of a process performed by the relay device according to the first embodiment, and the advantage of the first embodiment.

FIG. 1 is a schematic diagram illustrating an example configuration of a relay system according to a first embodiment. As illustrated in FIG. 1, a relay system 1 according to the first embodiment includes relay devices 10, 11, 12, 20, 21, 22, 30, 31, and 32. The relay device 10 is connected to the relay devices 11 and 20 such that they can communicate with each other. The relay device 11 is connected to the relay devices 10, 12, and 21 such that they can communicate with each other. The relay device 12 is connected to the relay devices 11 and 22 such that they can communicate with each other. The relay device 20 is connected to the relay devices 10, 21, and 30 such that they can communicate with each other. The relay device 21 is connected to the relay devices 11, 20, 22, and 31 such that they can communicate with each other. The relay device 22 is connected to the relay devices 12, 21, and 32 such that they can communicate with each other. The relay device 30 is connected to the relay devices 20 and 31 such that they can communicate with each other. The relay device 31 is connected to the relay devices 21, 30, and 32 such that they can communicate with each other. The relay device 32 is connected to the relay devices 22 and 31 such that they can communicate with each other.

One of the relay devices illustrated in FIG. 1 is set as a parent node that creates an initialization packet immediately after its power supply is turned on. For the embodiment, a description will be given with the assumption that the relay device 10 functions as a parent node and the relay devices 11, 12, 20, 21, 22, 30, 31 and 32 function as child nodes. Furthermore, because the operations of the relay devices 11, 12, 20, 21, 22, 30, 31, and 32 are the same, only the operation of the relay device 11 will be described.

The relay device 10, which is the parent node, determines whether it is itself a parent node that sends a set value to the other relay devices. If the relay device 10 determines that it is a parent node, the relay device 10 sends the set value stored in its storing unit to all of the other relay devices to which the relay device 10 is connected.

The relay device 11, which is a child node, determines whether it is itself a parent node that sends a set value to the other relay devices. If the relay device 11 determines that it is not a parent node, the relay device 11 then receives a set value and sets the received set value in its storing unit. Then, the relay device 11 itself determines whether the received set value has been sent from the relay device 11 to the other relay devices. If it is determined that the received set value has not been sent to the other relay devices from the relay device 11, the relay device 11 sends the set value to the other relay devices to which the relay device 11 is connected.

Operation of a Process Performed by the Relay System According to the First Embodiment

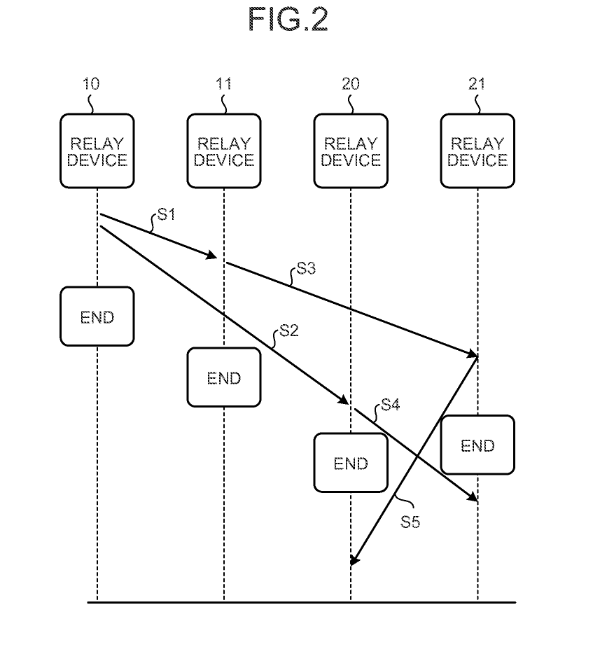

In the following, the operation of a process performed by a relay device when an initial setting is given to each of the relay devices illustrated in FIG. 1 will be described with reference to FIG. 2. FIG. 2 is a schematic diagram illustrating the operation of a process performed by a relay device. A description will be given, as an example, of an initial setting process performed among the relay devices 10, 11, 20, and 21 illustrated in FIG. 1. Furthermore, a description will be given with the assumption that the relay device 10 is a parent node and the relay devices 11, 20, and 21 are child nodes.

After an administrator sets the relay device 10, which is the parent node, to a set value that defines its operation, the relay device 10 creates an initialization packet in which the set value is stored, sends the created initialization packet to the relay device 11 and the relay device 20, and then ends the process (S1 and S2). The relay device 11 extracts an initial value from the initialization packet received from the relay device 10 and then sets the extracted initial value in the relay device 11. Then, the relay device 11 determines whether it has sent the initialization packet. If it is determined that the relay device 11 has not sent the initialization packet, the relay device 11 transfers the initialization packet to the relay device 21 (S3) and ends the process.

Similarly, the relay device 20 extracts the initial value from the initialization packet received from the relay device 10 and sets the extracted initial value in the relay device 20. Then, the relay device 20 determines whether it has sent the initialization packet. If it is determined that the relay device 20 has not sent the initialization packet, the relay device 20 transfers the initialization packet to the relay device 21 (S4) and ends the process.

Furthermore, the relay device 21 extracts the initial value from the initialization packet received from the relay device 11 and sets the extracted initial value in the relay device 21. Then, the relay device 21 determines whether it has sent the initialization packet. If it is determined that the relay device 21 has not sent the initialization packet, the relay device 21 transfers the initialization packet to the relay device 20 (S5) and ends the process.

At this point, if the relay device 20 receives the initialization packet from the relay device 21, because the relay device 20 has already received the initialization packet, the relay device 20 does not transfer the received initialization packet to the other relay device. Similarly, if the relay device 21 receives the initialization packet from the relay device 20, because the relay device 21 has already received the initialization packet, the relay device 21 does not transfer the received initialization packet to the other relay device.

In this way, in the relay system 1, the relay device 10 functioning as a parent node sends an initialization packet. Then, the one of the relay devices 11, 20, and 21 that received the initialization packet extracts an initial value from the received initialization packet and sets the extracted initial value in its own relay device. Furthermore, the one of the relay devices 11, 20, and 21 that received the initialization packet determines whether it has sent the initialization packet. If the relay device that received the initialization packet determines that it has not sent the initialization packet, it then transfers the initialization packet to the relay devices 11, 20, and 21 that are not the sending source. In contrast, if it is determined that the relay device that received the initialization packet has sent the initialization packet, it does not transfer the initialization packet to the relay devices 11, 20, and 21 that are not the sending source.

Configuration of the Relay Device According to the First Embodiment

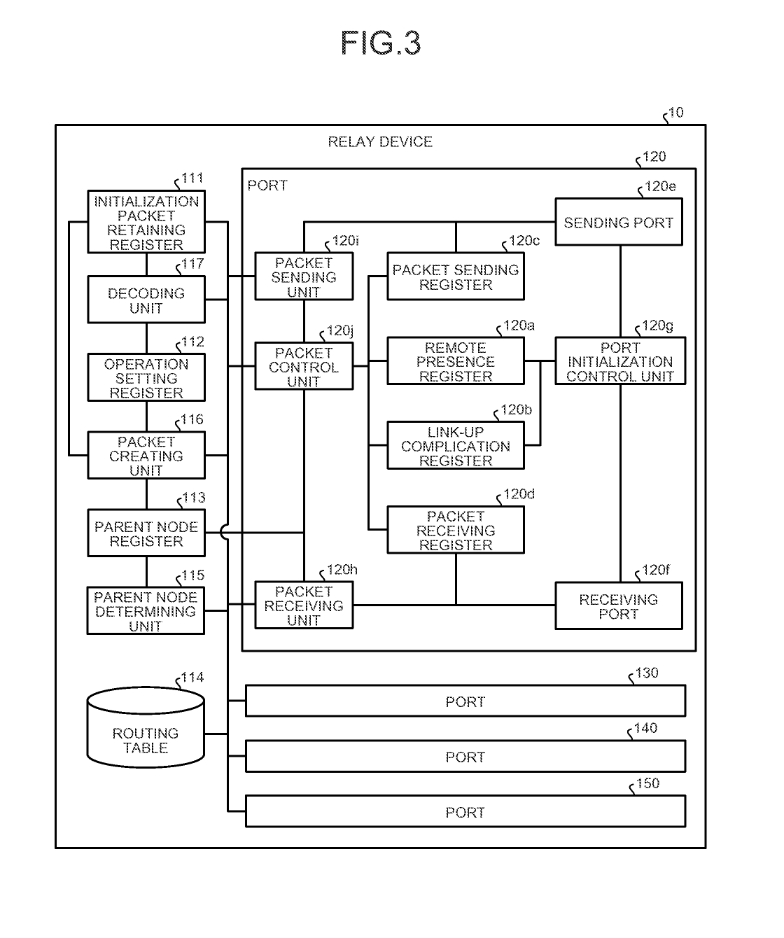

In the following, the configuration of the relay device according to the first embodiment will be described with reference to FIG. 3. FIG. 3 is a block diagram illustrating the configuration of the relay device according to the first embodiment. The configurations of the relay devices 10, 11, 12, 20, 21, 22, 30, 31, and 32 are the same; therefore, only the configuration of the relay device 10 will be described below as an example.

The relay device 10 according to the first embodiment includes an initialization packet retaining register 111, an operation setting register 112, a parent node register 113, a routing table 114, a parent node determining unit 115, a packet creating unit 116, and a decoding unit 117. Furthermore, the relay device 10 according to the first embodiment includes a port 120, a port 130, a port 140, and a port 150. Here, a description will be given with the assumption that the number of ports included in the relay device 10 is four; however, the number of ports included in the relay device 10 is not limited thereto and an arbitrary number of ports may also be set.

If the relay device 10 is a child node, the initialization packet retaining register 111 retains an initialization packet received from a packet receiving unit 120h. Furthermore, if the relay device 10 is a parent node, the initialization packet retaining register 111 retains the initialization packet received from the packet creating unit 116.

The operation setting register 112 is a register that stores therein various set values that define the operation of the relay device 10. For example, the operation setting register 112 stores therein set values, such as the size of a sending buffer, the flow of an error correction process, and the system configuration, which are used for the operation of the relay device.

Furthermore, if the relay device 10 is set as a parent node, the operation setting register 112 receives a setting of an initial value from an administrator by using a management terminal (not illustrated) via a system management bus (SMBus). If the relay device 10 is set as a child node, the operation setting register 112 receives a setting of the initial value that is extracted from the initialization packet by the decoding unit 117.

The parent node register 113 is a register that stores therein an identifier for determining whether the relay device 10 is a parent node. For example, if the relay device 10 is a parent node, “1” is stored in the parent node register 113, whereas if the relay device 10 is not a parent node, i.e., is a child node, “0” is stored in the parent node register 113.

Furthermore, if the relay device 10 is set as a parent node, “1” indicating that the relay device 10 is a parent node is stored in the parent node register 113 by an administrator via the management terminal (not illustrated) connected by the system management bus (SMBus).

The routing table 114 is information in which a destination address is associated with a sending port. For example, the routing table 114 is stored in a storage device, such as a semiconductor memory device or a hard disk. If a packet received by the packet receiving unit 120h via a receiving port 120f is transferred to another communication device, the routing table 114 is referred to by a packet control unit 120j.

The parent node determining unit 115 checks the identifier stored in the parent node register 113 and determines whether the relay device 10 is a parent node and is triggered to perform the checking when the power supply of the relay device 10 is turned on. For example, if “1” is stored in the parent node register 113, the parent node determining unit 115 determines that the relay device 10 is a parent node. Furthermore, if “0” is stored in the parent node register 113, the parent node determining unit 115 determines that the relay device 10 is a child node.

Furthermore, if the parent node determining unit 115 determines that the relay device 10 is a parent node, the parent node determining unit 115 notifies the packet creating unit 116, the decoding unit 117, and the packet control unit 120j, which will be described later, that the relay device 10 is a parent node. Similarly, if it is determined that the relay device 10 is a child node, the parent node determining unit 115 notifies the packet creating unit 116, the decoding unit 117, and the packet control unit 120j, which will be described later, that the relay device 10 is a child node. Furthermore, the parent node determining unit 115 is an example of the first determining unit.

If the packet creating unit 116 receives, from the parent node determining unit 115, a notification that the relay device 10 is a parent node, the packet creating unit 116 creates an initialization packet. For example, the packet creating unit 116 extracts a set value that is set in the operation setting register 112 and then creates an initialization packet from the extracted set value. Then, the packet creating unit 116 outputs the created initialization packet to the initialization packet retaining register 111.

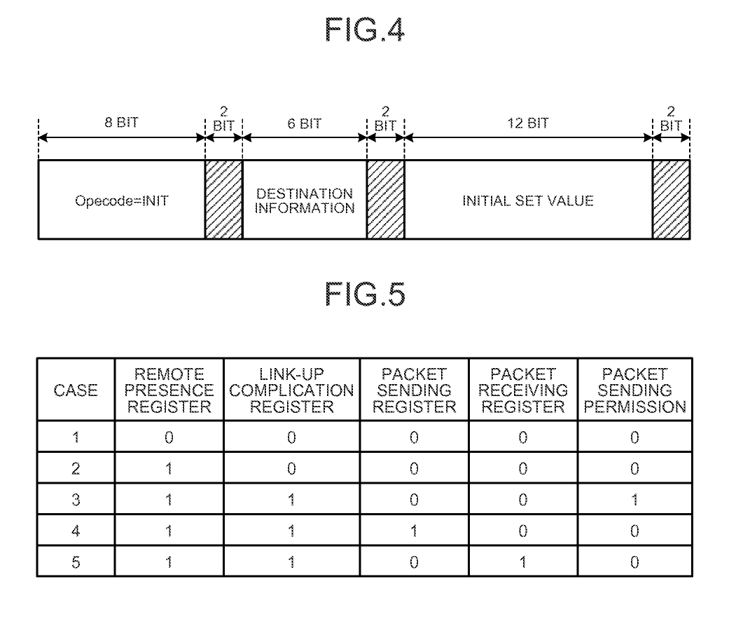

In the following, an initialization packet created by the packet creating unit 116 will be described with reference to FIG. 4. FIG. 4 is a schematic diagram illustrating an initialization packet created by a packet creating unit. The initialization packet illustrated in FIG. 4 includes, from the top of the packet, an 8-bit “Opecode”, a 2-bit arbitrary value, 6-bit “destination information”, a 2-bit arbitrary value, a 12-bit “initial set value”, and a 2-bit arbitrary value.

Here, in the “Opecode” included in the packet, “INIT” indicating that a packet is an initialization packet is stored. Furthermore, because the “destination information” is not directly referred to in the future operation, an arbitrary value may also be set. Furthermore, in the “initial set value”, various set values that define the operation of the relay device 10 are stored. For example, in the “initial set value”, a value stored in the operation setting register 112 is stored. The initialization packet illustrated in FIG. 4 is only an example and is not limited thereto. For example, an arbitrary value set by an administrator is stored in the “initial set value”. The packet creating unit 116 is an example of an extracting unit and the initial set value is an example of a set value.

A description will be given here by referring back to FIG. 3. If the decoding unit 117 receives, from the parent node determining unit 115, a notification that the relay device 10 is a child node, the decoding unit 117 extracts an initial value from the initialization packet retained in the initialization packet retaining register 111 and sets the extracted initial value in the operation setting register 112.

For example, if the decoding unit 117 receives, from the parent node determining unit 115, a notification that the relay device 10 is a child node, the decoding unit 117 regularly monitors the initialization packet retaining register 111 and determines whether an initialization packet is retained. If it is determined that an initialization packet is retained in the initialization packet retaining register 111, the decoding unit 117 extracts an initial value from the initialization packet and sets the extracted initial value in the operation setting register 112. If the decoding unit 117 sets the extracted initial value in the operation setting register 112, the decoding unit 117 ends the monitoring of the initialization packet retaining register 111. In contrast, if it is determined that an initialization packet is not retained in the initialization packet retaining register 111, the decoding unit 117 continues to monitor the initialization packet retaining register 111. The decoding unit 117 is an example of a setting unit.

The packet creating unit 116 and the decoding unit 117 are integrated circuits, such as an application specific integrated circuit (ASIC) or a field programmable gate array (FPGA). Alternatively, the packet creating unit 116 and the decoding unit 117 are electronic circuits, such as a central processing unit (CPU) or a micro processing unit (MPU).

The port 120 includes a remote presence register 120a, a link-up complication register 120b, a packet sending register 120c, a packet receiving register 120d, a sending port 120e, and the receiving port 120f. Furthermore, the port 120 includes a port initialization control unit 120g, the packet receiving unit 120h, a packet sending unit 120i, and the packet control unit 120j. The configurations of the ports 120, 130, 140, and 150 are the same; therefore, only the configuration of the port 120 will be described below and descriptions of the ports 130, 140, and 150 will be omitted.

The remote presence register 120a is a register that stores therein an identifier for determining whether an opposing port can be detected. For example, “1” is stored in the remote presence register 120a if an opposing port can be detected, whereas “0” is stored if an opposing port is not able to be detected.

The link-up complication register 120b is a register that stores therein an identifier indicating whether a link up with an opposing port has been completed. For example, “1” is stored in the link-up complication register 120b if a link up with an opposing port has been completed, whereas “0” is stored if a link up with an opposing port has not been completed.

The packet sending register 120c is a register that stores therein an identifier indicating whether the relay device 10 has sent an initialization packet from the port 120. For example, “1” is stored in the packet sending register 120c if an initialization packet has been sent from the port 120, whereas “0” is stored if an initialization packet has not been sent from the port 120.

The packet receiving register 120d is a register that stores therein an identifier indicating whether the relay device 10 has received an initialization packet from the port 120. For example, “1” is stored in the packet receiving register 120d if an initialization packet has been received from the port 120, whereas “0” is stored if an initialization packet has not been received from the port 120.

The sending port 120e is a port that is connected, via a transmission line, to a receiving port of an opposing communication device (not illustrated) and sends a packet to the opposing communication device. The receiving port 120f is a port that is connected, via a transmission line, to a sending port of an opposing communication device (not illustrated) and receives a packet from the opposing communication device. The receiving port or the sending port of the opposing communication device is referred to as an “opposing port”.

The port initialization control unit 120g determines whether an opposing port can be detected. If an opposing port can be detected, the port initialization control unit 120g writes “1” into the remote presence register 120a. Furthermore, the port initialization control unit 120g determines whether a link up with an opposing port has been completed. If a link up with an opposing port has been completed, the port initialization control unit 120g writes “1” into the link-up complication register 120b.

If a packet received via the receiving port 120f is an initialization packet, the packet receiving unit 120h stores the initialization packet in the initialization packet retaining register 111. At this point, when the packet receiving unit 120h reads the “Opecode” in the packet received via the receiving port 120f, if “INIT” is stored, the packet receiving unit 120h determines that the packet received via the receiving port 120f is an initialization packet.

Furthermore, if the packet received via the receiving port 120f is an initialization packet, the packet receiving unit 120h notifies the packet control unit 120j that the received packet is the initialization packet. Furthermore, if the packet received via the receiving port 120f is an initialization packet, the packet receiving unit 120h writes “1” into the packet receiving register 120d. The packet receiving unit 120h is an example of a receiving unit.

The packet sending unit 120i duplicates the initialization packet retained in the initialization packet retaining register 111 and extracts the duplicated initialization packet from the initialization packet retaining register 111. Then, the packet sending unit 120i notifies the packet control unit 120j that the duplicated initialization packet has been extracted from the initialization packet retaining register 111.

Furthermore, if the packet control unit 120j permits the packet sending unit 120i to send the initialization packet, the packet sending unit 120i outputs the duplicated initialization packet to the sending port 120e. Furthermore, if the packet sending unit 120i outputs the initialization packet to the sending port 120e, the packet sending unit 120i writes “1” into the packet sending register 120c. Furthermore, when the packet sending unit 120i reads the “Opecode” in the extracted packet, if “INIT” is stored, the packet sending unit 120i determines that the extracted packet is an initialization packet. The packet sending unit 120i is an example of a first sending unit and a second sending unit.

The packet control unit 120j determines whether an initialization packet is sent on the basis of the values stored in the packet sending register 120c and the packet receiving register 120d. The packet control unit 120j is an example of a second determining unit and a third determining unit. In the following, packet sending permission obtained by the packet control unit 120j on the basis of the contents of the register, i.e., the remote presence register 120a, the link-up complication register 120b, the packet sending register 120c, and the packet receiving register 120d, will be described with reference to FIG. 5.

FIG. 5 is a table illustrating the result of determining, performed by a packet control unit on the basis of the content of each register, as to whether a packet has permission to be sent. In the following, a description will be given of the result of determining, performed by the packet control unit 120j, as to whether a packet has permission to be sent in a case in which the relay device 10 is a parent node or in a case in which the relay device 10 is a child node. Here, a description will be given of the operation of the packet control unit 120j when the relay device 10 permits sending of an initialization packet to all of the ports in which a link up has been completed and that are other than a port that has received an initialization packet.

Case in which the Relay Device 10 is a Parent Node

In the following, a description will be given of the operation of a determining process for determining whether to permit packet transmission performed by the packet control unit 120j when a notification that the relay device 10 is a parent node is received from the parent node determining unit 115. If the remote presence register stores therein “0”, the packet control unit 120j does not permit sending of an initialization packet (case 1 in FIG. 5). Even when the remote presence register stores therein “1”, if the link-up complication register stores therein “0”, the packet control unit 120j does not permit sending of an initialization packet (case 2 in FIG. 5). In both cases 1 and 2, the processes are also performed even if the relay device is a child node.

If the remote presence register stores therein “1”, if the link-up complication register stores therein “1”, if the packet sending register stores therein “0”, and if the packet receiving register stores therein “0”, the packet control unit 120j permits sending of an initialization packet (case 3 in FIG. 5). If the packet sending unit 120i sends an initialization packet and then “1” is stored in the packet sending register, the packet control unit 120j shifts the state to a state in which the sending of an initialization packet is not permitted (case 4 in FIG. 5).

Case in which the Relay Device 10 is a Child Node

In the following, a description will be given of the operation of a determining process for determining whether to permit packet transmission performed by the packet control unit 120j when a notification is received from the parent node determining unit 115 that the relay device 10 is a child node. First, a description will be given of a case in which one of the ports 130 to 150 other than the port 120 that includes the packet control unit 120j receives an initialization packet. Then, a description will be given of a case in which the port 120 that includes the packet control unit 120j receives an initialization packet. Similarly when the relay device 10 is a parent node, when the relay device 10 is a child node, the relay device 10 also shifts the state from the case 1 to the case 2; however, the descriptions of the states of the cases 1 and 2 will be omitted.

First, a description will be given of a case in which one of the ports 130 to 150 other than the port 120 that includes the packet control unit 120j receives an initialization packet. If the remote presence register stores therein “1”, if the link-up complication register stores therein “1”, if the packet sending register stores therein “0”, and if the packet receiving register stores therein “0”, the packet control unit 120j permits sending of an initialization packet (case 3 in FIG. 5). Thereafter, if the packet sending unit 120i sends an initialization packet and then “1” is written into the packet sending register, the packet control unit 120j shifts the state to a state in which sending of an initialization packet is not permitted (case 4 in FIG. 5).

In the following, a description will be given of a case in which the port 120 that includes the packet control unit 120j receives an initialization packet. The relay device 10 according to the first embodiment sends the initialization packet to the ports 130 to 150 other than the port 120 that has received the initialization packet. For example, even if the remote presence register stores therein “1”, the link-up complication register stores therein “1”, and the packet sending register stores therein “0”, if the packet receiving register stores therein “1”, the packet control unit 120j does not permit sending of an initialization packet (case 5 in FIG. 5).

The port initialization control unit 120g, the packet receiving unit 120h, the packet sending unit 120i, the packet control unit 120j are integrated circuits, such as application specific integrated circuits (ASIC) or field programmable gate arrays (FPGA). Alternately, the port initialization control unit 120g, the packet receiving unit 120h, the packet sending unit 120i, and the packet control unit 120j are electronic circuits, such as central processing units (CPU) or micro processing units (MPU).

Flow of a Process Performed by the Relay Device According to the First Embodiment

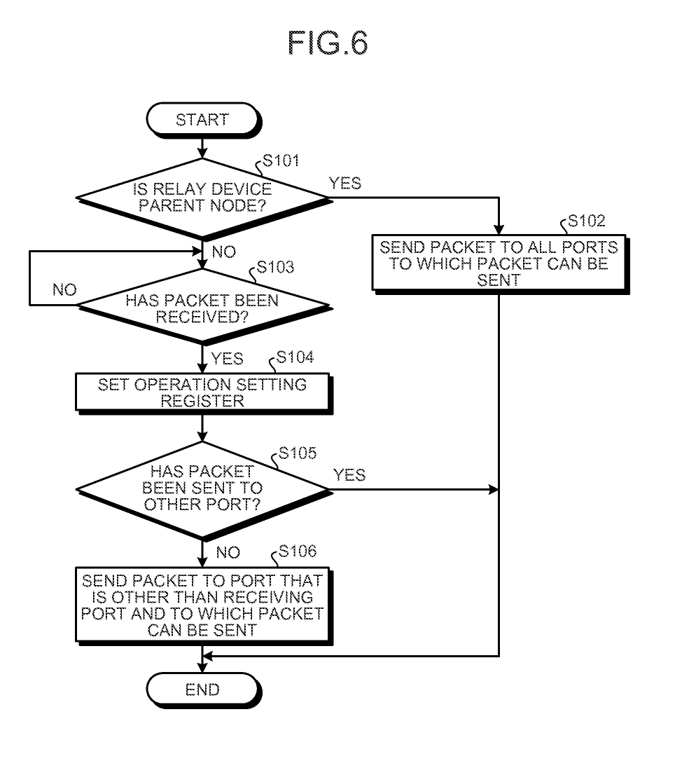

In the following, the flow of a process performed by the relay device 10 according to the first embodiment will be described with reference to FIG. 6. FIG. 6 is a flowchart illustrating the flow of a process performed by the relay device according to the first embodiment. This process is performed, for example, when the power supply of the relay device 10 is turned on.

As illustrated in FIG. 6, the relay device 10 determines immediately after its power supply is turned on whether it is set as a parent node (Step S101). If the relay device 10 determines that it is a parent node (Yes at Step S101), the relay device 10 creates an initialization packet, sends the initialization packet to all of the ports to which the packet can be sent (Step S102), and then ends the process.

In contrast, if the relay device 10 determines that it is not a parent node (No at Step S101), the relay device 10 determines whether it has received the initialization packet from a parent node (Step S103). At this point, if the relay device 10 determines that it has not received the initialization packet from a parent node (No at Step S103), the relay device 10 stops the process until it receives the initialization packet. In contrast, if the relay device 10 determines that it has received the initialization packet from a parent node (Yes at Step S103), the relay device 10 extracts an initial value from the received initialization packet and stores the extracted initial value in the operation setting register 112.

Then, the relay device 10 determines whether it has already sent the initialization packet to another port (Step S105). If it is determined that the relay device 10 has not yet sent the initialization packet to another port (No at Step S105), the relay device 10 sends the initialization packet to a port that is other than the receiving port and to which the packet can be sent (Step S106) and then ends the process. In contrast, if the relay device 10 determines that the relay device 10 has already sent the initialization packet to another port (Yes at Step S105), the relay device 10 ends the process. Specifically, even if the relay device 10 receives the initialization packet, the relay device 10 does not send the received initialization packet.

Advantage of the First Embodiment

As described above, if the relay device 10 is a parent node, the relay device 10 according to the first embodiment creates an initialization packet and sends the created initialization packet to all of the other relay devices to which the relay device 10 is connected. Furthermore, if the relay device 10 is a child node, the relay device 10 extracts an initial value from the initialization packet received from the other relay device and then sets itself to the extracted initial value. In this way, immediately after their power supply is turned on, the relay device 10 can, by sending a packet, sets all of the relay devices, which are in the relay system 1 and in which a routing table has not been set, to an initial value.

Furthermore, the relay device 10 according to the first embodiment determines whether it has already sent a packet. If it is determined that it has already sent a packet, the relay device 10 does not send the received packet to the other relay devices. Consequently, with the relay device, there is no occurrence of looping of a packet, in which the initialization packet that is received after the end of the initial setting is repeatedly sent to the other relay devices.

Furthermore, the relay device 10 according to the first embodiment sends an initialization packet to the other relay devices that are connected to all of the ports other than a port that has already received the initialization packet. Consequently, the relay device 10 can reduce the number of times a packet is sent when compared with a case in which a packet is sent to all of the relay devices in which a link up has been completed.

The configuration of the relay device 10 illustrated in FIG. 3 is only an example and the relay device 10 does not need to include all of the processing units illustrated in FIG. 3. For example, the relay device 10 may only include the parent node determining unit 115, the packet creating unit 116, the decoding unit 117, the packet receiving unit 120h, the packet sending unit 120i, and the packet control unit 120j.

### [b] Second Embodiment

The relay device disclosed in the present invention may also be implemented with various kinds of embodiments other than the embodiment described above. Therefore, in a second embodiment, another embodiment of the relay device disclosed in the present invention will be described.

System Configuration, Etc

Of the processes described in the embodiment, the whole or a part of the processes that are mentioned as being automatically performed can be manually performed, or the whole or a part of the processes that are mentioned as being manually performed can be automatically performed using known methods.

Furthermore, process procedures, the control procedures, and the specific names indicated in the above specification and drawings can be arbitrarily changed unless otherwise noted. For example, if the relay device 10 is a child node, after sending an initialization packet to another relay device, the relay device 10 may also extract an initial value from the initialization packet retained in the initialization packet retaining register 111 and set the extracted initial value in the operation setting register 112.

Furthermore, the relay device that can be used in the present invention may also be used for a router or an L2 switch. Furthermore, a description has been given of a relay device that sends and receives a packet in which a set value is stored; however, the set value is not limited to being included in a packet. For example, a set value may also be included in, a frame, a datagram, a segment, and a message and then exchanged.

Furthermore, in the first embodiment, the relay device 10 sends an initialization packet to a port other than a port that has received the initialization packet; however, the present invention is not limited thereto. For example, it may also be possible to configure the relay device 10 such that it also sends an initialization packet to a port that has received the initialization packet. In such a case, the packet control unit 120j permits sending of an initialization packet even if the packet receiving unit 120h that has received the initialization packet via the port 120 writes “1” into the packet receiving register. Then, if the initialization packet is sent by the packet sending unit 120i and “1” is written into the packet sending register, the packet control unit 120j shifts the state to a state in which the sending of the initialization packet is not permitted.

Furthermore, in the first embodiment, the parent node determining unit 115 performs a process when the power supply of the relay device is turned on; however, the present invention is not limited thereto. For example, if the parent node determining unit 115 receives, from an administrator, a resetting of a set value is received while the relay system is running, the parent node determining unit 115 may also perform a process for determining whether the relay device 10 is a parent node when the resetting of the set value is received.

Furthermore, in the relay system, after starting the operation of the system, the relay device that is set as a parent node may also be changed to a child node and one of the relay devices set as child nodes may also be changed to a parent node. For example, by rewriting the identifier “1” stored in the parent node register 113 to “0” by using the management terminal that is connected via the SMBus, the administrator changes the relay device that is set as a parent node to a child node. Furthermore, by rewriting the identifier “0” stored in the parent node register 113 to “1” by using the management terminal that is connected via the SMBus, the administrator changes one of the relay devices that is set as a child node to a parent node.

Furthermore, if the relay device 10 is permanently fixed to operate as a parent node, the relay device 10 does not need to include all of the processing units illustrated in FIG. 3 and it may only have a function of performing a process performed by a parent node. For example, the relay device 10 that is permanently fixed to operate as a parent node does not need to include the parent node determining unit 115, the decoding unit 117, and the packet receiving unit 120h. Furthermore, if the relay device 10 is permanently fixed to operate as a child node, the relay device 10 does not need to include all of the processing units illustrated in FIG. 3 and it may only have a function of performing a process performed by a child node. For example, the relay device 10 that is permanently fixed to operate as a child node is allowed to remove the parent node determining unit 115 and the packet creating unit 116.

The components of each unit illustrated in the drawings are only for conceptually illustrating the functions thereof and are not always physically configured as illustrated in the drawings. For example, in the relay device 10, the packet creating unit 116 and the decoding unit 117 may also be integrated. Furthermore, all or any part of the processing functions performed by each device can be implemented by a CPU and by programs analyzed and executed by the CPU or implemented as hardware by wired logic.

Program

The various processes described in the above embodiments may also be implemented by a program prepared in advance and executed by a computer, such as a personal computer or a workstation. Accordingly, in the following, an example of a computer that executes a program having the same function as that described in the above embodiments will be described as an example.

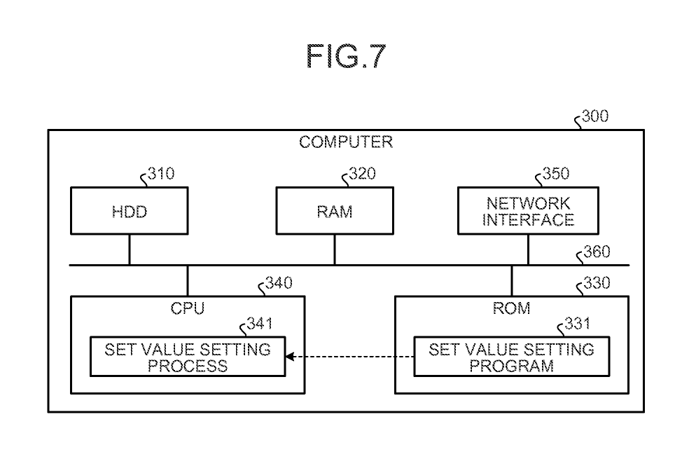

FIG. 7 is a block diagram illustrating a computer that executes a set value setting program. As illustrated in FIG. 7, a computer 300 includes a hard disk drive (HDD) 310, a RAM 320, a read only memory (ROM) 330, a CPU 340, a network interface 350 that exchange data with another device, and a bus 360. Each of the devices 310 to 350 are connected to the bus 360.

The ROM 330 illustrated in FIG. 7 stores therein, in advance, a set value setting program 331. The set value setting program 331 has the same function as that executed by the parent node determining unit 115, the packet creating unit 116, the decoding unit 117, the packet receiving unit 120h, the packet sending unit 120i, and the packet control unit 120j illustrated in FIG. 3.

Then, the CPU 340 reads the set value setting program 331 from the ROM 330 and executes it as a set value setting process 341. Specifically, the set value setting process 341 performs the same operation as that performed by the parent node determining unit 115, the packet creating unit 116, the decoding unit 117, the packet receiving unit 120h, the packet sending unit 120i, and the packet control unit 120j illustrated in FIG. 3.

The set value setting program 331 is not always stored in the ROM 330. For example, the set value setting program 331 may also be stored in a “portable physical medium”, such as a flexible disk (FD), a CD-ROM, a DVD disk, a magneto-optic disk, an IC CARD, or the like, that can be inserted into the computer 300. Alternatively, the program may also be stored in a “fixed physical medium”, such as an HDD that can be arranged inside/outside the computer 300. Alternatively, the program may also be stored in “another computer” connected to the computer 300 via a public circuit, the Internet, a local area network (LAN), a wide area network (WAN), or the like. Then, the computer 300 may also read and execute the program from the flexible disk or the like described above.

Specifically, the programs described in the embodiment can be stored in a computer-readable recording medium, such as the “portable physical medium”, the “fixed physical medium”, or the “communication medium” described above. Then, the computer 300 reads the programs from the recording medium and executes them so as to implement the same function as that described in the embodiment. The program mentioned in this embodiment is not limited to a process performed by the computer 300. For example, the present invention can also be used in a case in which another computer system or server executes the programs or executes the programs in a cooperative manner.

According to an aspect of the present invention, an advantage is provided in that it is possible to efficiently set a set value in multiple relay devices.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay device comprising:
a first determining unit that determines whether the relay device is a parent node that sends a set value to other relay devices;
a first sending unit that sends, when the first determining unit determines that the relay device is the parent node, the set value stored in a storing unit to all of the other relay devices to which the relay device is connected;
a receiving unit that receives the set value when the first determining unit determines that the relay device is not the parent node;
a setting unit that sets the set value received by the receiving unit in the storing unit;
a second determining unit that determines whether the set value received by the receiving unit has been sent from the relay device to the other relay devices; and
a second sending unit that sends, when the second determining unit determines that the received set value has not been sent to the other relay devices, the received set value to the other relay devices to which the relay device is connected.

2. The relay device according to claim 1, further comprising a third determining unit that determines whether the set value stored in the storing unit has been sent to the other relay devices, wherein, when the third determining unit determines that the set value has not been sent to the other relay devices, the first sending unit sends the set value to the other relay devices to which the relay device is connected.

3. The relay device according to claim 1, wherein the second sending unit sends the set value to all of the other relay devices other than the other relay device that is the transmission source of the set value from among the other relay devices to which the relay device is connected.

4. A relay device according to claim 1, further comprising an extracting unit that extracts the set value stored in the storing unit, when the first determining unit determines that the relay device is the parent node, and wherein
the first sending unit sends the set value extracted by the extracting unit to all other relay devices to which the relay device is connected.

5. A set value setting method comprising:
first determining, performed by a relay device, whether the relay device is a parent node that sends a set value to other relay devices;
first sending, performed by the relay device, when it is determined that the relay device is the parent node, the set value stored in a storing unit to all of the other relay devices to which the relay device is connected;
receiving, performed by the relay device, the set value when it is determined that the relay device is not the parent node;
setting, performed by the relay device, the set value received at the receiving in the storing unit;
second determining, performed by the relay device, whether the set value received at the receiving has been sent from the relay device to the other relay devices; and
second sending, performed by the relay device, when it is determined that the set value has not been sent to the other relay devices, the set value to the other relay devices to which the relay device is connected.

6. A set value setting method according to claim 5, further comprising:
extracting, performed by the relay device, the set value stored in the storing unit, when it is determined that the relay device is the parent node, and wherein
the first sending includes sending, performed by the relay device, the extracted set value extracted at the extracting to all of other relay devices to which the relay device is connected.

7. A computer-readable recording medium having stored therein a program for causing a computer that is included in a relay device to execute a process for setting a set value, the process comprising:
first determining whether the relay device is a parent node that sends a set value to other relay devices;
first sending, when it is determined that the relay device is the parent node, the set value stored in a storing unit to all of the other relay devices to which the relay device is connected;
receiving the set value when it is determined that the relay device is not the parent node;
setting the received set value in the storing unit;
second determining whether the set value at the receiving has been sent from the relay device to the other relay devices; and
second sending, when it is determined that the set value received at the receiving has not been sent to the other relay devices, the set value received at the receiving to the other relay devices to which the relay device is connected.

8. A relay system comprising:
a parent node that is a relay device that sends a set value to other relay devices; and
multiple child nodes that are the other relay devices that receive the set value, wherein
the parent node includes
a first sending unit that sends the set value stored in a storing unit to all of the other relay devices to which the relay device is connected, and
the child node includes
a receiving unit that receives the set value,
a setting unit that sets the set value received by the receiving unit in the storing unit,
a second determining unit that determines whether the set value received by the receiving unit has been sent from the relay device to the other relay devices to which the relay device is connected, and
a second sending unit that sends, when the second determining unit determines that the set value has not been sent to the other relay devices, the set value to the other relay devices to which the relay device is connected.
